(19) United States
(12) Patent Application Publication
(10) Pub. No.: US 2025/0002385 A1
(43) Pub. Date: Jan. 2, 2025

(54) COMBINED METHOD FOR CARBON SEQUESTRATION AND WATER TREATMENT BY ELECTROCHEMICAL DEPOSITION

(71) Applicant: TECHNION RESEARCH & DEVELOPMENT FOUNDATION LIMITED, Haifa (IL)

(72) Inventors: Charlotte VOGT, Haifa (IL); Noam ZISSER GAL, Haifa (IL); Noam KARO, Haifa (IL); Or MAYRAZ, Haifa (IL); Assaf LICHT, Haifa (IL)

(21) Appl. No.: 18/829,492

(22) Filed: Sep. 10, 2024

Related U.S. Application Data
(63) Continuation of application No. PCT/IL2023/050257, filed on Mar. 13, 2023.
(60) Provisional application No. 63/319,332, filed on Mar. 13, 2022.
(60) Provisional application No. 63/392,538, filed on Jul. 27, 2022.

(51) Int. Cl. C02F 5/02; C02F 5/10; C02F 101/30; C02F 103/00

(52) U.S. Cl. CPC C02F 5/02; C02F 5/105; C02F 2101/30; C02F 2103/007; C02F 2201/002; C02F 2201/4618; C02F 2303/08; C02F 2303/20

(57) ABSTRACT

A combined method for carbon sequestration and water treatment is described in the present invention. Said carbon sequestration comprises capturing atmospheric carbon dioxide in an aqueous solution, and said water treatment comprises simultaneous removal of said carbon dioxide from said aqueous solution by electrochemical deposition of metal carbonates, hydroxides and/or mixed salts crystallised on crystallisation seeds or beads. The metal carbonates, hydroxides and mixed salts are insoluble or sparingly soluble inorganic compounds obtained from the captured carbon dioxide by chemical reactions with water and metal cations contained in said pre-treated water. The crystallisation seeds are seeding crystals serving as nucleation centres for crystal growth of the metal carbonates, hydroxides and/or mixed salts from the alkaline stream. The crystallisation seeds and beads are optionally chemically modified with chemical functional groups to provide selective tuneable purity to the crystalline metal carbonates, hydroxides and/or mixed salts crystallised on said seeds or beads.

### CROSS REFERENCE TO RELATED APPLICATIONS

This application is a Bypass Continuation of PCT Patent Application No. PCT/IL2023/050257 having International filing date of Mar. 13, 2023, which claims the benefit of priority of U.S. Provisional Patent Application Nos. 63/319,332, filed Mar. 13, 2022 and 63/392,538, filed Jul. 27, 2022, the contents of which are all incorporated herein by reference in their entirety.

### TECHNICAL FIELD

The present application relates to the field of reducing global climate change. In particular, the present application relates to the combination of carbon sequestration and water treatment technologies using low electrode area electrochemical deposition.

### BACKGROUND

Carbon sequestration is a method of reducing the amount of carbon dioxide in the atmosphere with the goal of reducing global climate change. It is based on the process of capturing and storing atmospheric carbon dioxide. Converting carbon dioxide to precipitated mineral carbonate using an ex-situ mineral carbonation process is considered a promising option for carbon sequestration because first, captured CO₂ can be stored permanently, second, the process can be used on a very large scale, and third, industrial waste (e.g., coal fly ash, steel and stainless-steel slags etc.), as well as cement and lime kiln dust, can be processed and converted into value-added carbonate materials by controlling the polymorphs and properties of mineral carbonates. The end products resulting from the ex-situ carbonisation of minerals can be divided into two categories: low-quality mineral carbonates in large volumes and high-quality mineral carbonates in small volumes in terms of their market needs as well as their properties (i.e., purity). Therefore, it is expected that this may partially offset the overall cost of CCS processes.

### Salts and the Carbonate Systems

An increase in atmospheric CO₂ causes an increase in ocean acidity due to the carbonate system described below. More dissolved CO₂ results in more protons through the formation of bicarbonates. This is a problem for two main reasons. Firstly, a more acidic ocean will affect the fragile ecosystem of marine biology. Ocean acidification can have many harmful effects on marine organisms, such as reduced metabolic rates and immune responses in some organisms, and coral bleaching. Ocean acidification affects marine ecosystems that provide food, livelihoods and other ecosystem services for a significant portion of the population. About 1 billion people depend wholly or partly on the ecosystem services provided by coral reefs for fisheries, tourism and coastal management.

Water, particularly sea water and brackish water, contains many different elements. Approximately 2.5-3.5% of water is made up of salts (roughly 600 mM), mainly sodium and chloride. Sulfate makes up approximately 7.7% of the total salts found in sea water, magnesium 3.7%, calcium approximately 1.2%, potassium 1.1% and other minor constituents making up the rest. The abundance of water on the planet, and its many different uses lead to a number of different problems, and opportunities regarding these dissolved salts in water, which are highlighted below.

There are two major mechanisms that control carbon dioxide concentrations in the Earth's atmosphere. The first works on timescales longer than 100,000 years and includes silicate-rock weathering feedback. The marine carbonate system, together with terrestrial biota, and soil influence the large majority of atmospheric CO₂ concentrations on the shorter yearly scale. The interaction of these reservoirs with atmospheric CO₂ and their different capacities for carbon storage through different mechanisms, in essence, determines the daily CO₂ levels in the atmosphere.

The carbonate ion in the ocean system is an intricate interplay of several carbon-containing layers, or entities. That is, the surface and deep oceans, sedimentary rocks, and the ocean biota each have different storage capacities, timescales of operation, and slightly different storage mechanisms. Briefly, the oceans themselves, as mentioned above contain several ions. These ions interact with carbon dioxide through a series of chemical equilibria, called the carbonate system of seawater, briefly illustrated with the following chemical equilibrium reactions:

CO₂(aq)+H₂O↔H₂CO₃(aq)

H₂CO₃↔HCO₃⁻+H⁺

HCO₃⁻↔HCO₃⁻+H⁺

Increasing amounts of CO₂ in the atmosphere cause an increase in the acidity of the ocean as more dissolved CO₂ leads to more protons by the formation of bicarbonates. This is a problem for two main reasons, firstly, because a more acidic ocean will affect the delicate ecosystem of marine biology. Acidification of the ocean can have many harmful effects on marine organisms such as depressing metabolic rates and immune responses in some organisms and causing coral bleaching. In other words, more acidic ocean can contain much less CO₂. Since most of the CO₂ available on Earth is now dissolved in the ocean, this would dramatically increase the adverse effects of the greenhouse effect due to the subsequent increase in the concentration of CO₂ in the air.

Thus, ocean acidification is impacting on the ecosystems of marine environments that provide food, livelihoods, and other ecosystem services for a large proportion of the human population. Some one billion people are wholly or partially dependent on the ecosystem services provided by coral reefs in terms of fishing, tourism, and coastal management. The other major way that ocean acidification impacts the environment negatively is due to the fact that the solubility of CO₂ is negatively correlated with increasing pH. That is, a more acidic ocean can hold less CO₂.

FIG. 1 shows a schematic simplified overview of the amount of carbon dioxide oscillating between air, land and the atmosphere in Gt (gigatonne)/y in the carbon cycle. The buildings represent the annual human contribution in Gt (gigatonne) of carbon dioxide. The trees represent land-based carbon dioxide movement of land-atmosphere, the ocean represents the ocean-base carbon dioxide movement of ocean-atmosphere. Data for the figure (FIG. 1) was obtained from the U.S. DOE, Biological and Environmental Research Information, and was converted to carbon dioxide movement by multiplying the data with the molecular weight ratio of carbon dioxide to carbon.

It is clear that the ocean plays a large role in our natural carbonate system, and it is seen as one of the most promising tools to manipulate to capture carbon in an attempt to halt anthropogenic climate change.

### Physical Ocean Capture Carbon Capture Methods

Calcium is one of the prevalent ions in sea water. This has gained recent interest through the concept of ocean alkalinity enhancement (OAE) which is one of the routes proposed to solve the acidification of the ocean, thereby allowing it to capture more CO₂. One of the ways through which this is proposed involves the dissolution of alkaline minerals such as quicklime (CaO) and hydrated lime (Ca(OH)₂) into sea water in order to increase its capacity to take up CO₂. This would occur through the reaction described below, eventually pushing the equilibrium towards the precipitation of more solid CaCO₃. This falls under the “chemical precipitation of minerals” route, where addition of calcium oxide (CaO) is described by the following chemical equation:

CaO+H₂O↔Ca(OH)₂+2CO₂↔Ca²⁺+2HCO₃⁻.

However, there are major constraints to this application of chemical precipitation of minerals, such as the difficulty to keep a CaCO₃ saturation state of the sea water below a critical threshold beyond which CaCO₃ would precipitate inorganically, which removes more alkalinity than is added by the addition of quicklime. Furthermore, it is clear that OAE relies on the continuous addition of quicklime and/or hydrated lime which is costly in terms of energy, emissions, and economics to mine.

There are currently several known physical ocean-based carbon dioxide capture methods, including:
1) Ocean alkalinity enhancement: This method involves adding a base (such as crushed limestone or other alkaline materials) to the ocean to increase its pH, which in turn increases the amount of dissolved CO₂ that the ocean can hold.
2) Ocean fertilisation: This method involves adding nutrients (such as iron or nitrogen) to the ocean to promote the growth of phytoplankton, which absorb CO₂ through photosynthesis.
3) Direct injection: This method involves injecting liquid CO₂ into the deep ocean, where it is stored in the form of a liquid or solid.
4) Ocean thermal energy conversion (OTEC): This method uses the temperature difference between the surface and deep ocean water to generate electricity, and the process can also be used to separate CO₂ from the air.
5) Seawater greenhouse: This method captures the heat energy of the sun by using seawater to warm the air inside a greenhouse, and then uses that energy to power the separation of CO₂ from the air.
6) Seawater-based carbon dioxide reduction: This method uses seawater to reduce CO₂ to form solid carbonates which can be stored away.

These methods are currently at various stages of development and testing. While some have been demonstrated to be effective on a small scale, their potential for large-scale deployment and their potential environmental impacts are still being far from satisfactory.

Bio-based carbon capture methods have very low scalability as they require lots of surface area. Traditional physical or chemical based methods are similar, requiring either large areas of land or polluting chemicals.

Electrochemistry offers new avenues to utilise clean, renewable electricity generally to influence the pH of water, but through different mechanisms. The current state of the art for electrochemical deposition of minerals is primarily focused on the use of electrochemical processes for the recovery of valuable metals and minerals from aqueous solutions. This includes the recovery of metals such as copper, nickel, zinc, and gold, as well as the recovery of minerals such as calcium carbonate, magnesium hydroxide, magnesium carbonate MgCO₃, and also basic magnesium carbonate (MgOH)₂CO₃. The latter are both thermodynamically and kinetically difficult to precipitate, as well as iron oxide.

Curing of calcium carbonate (descaling and precipitation) can be carried out electrochemically. Electrochemical scale control systems have been successfully used to reduce the hardness of, for example, water in cooling towers. The main disadvantage preventing their use in desalination plants is the very large area of the electrode. These two aforementioned applications (descaling and carbon sequestration) would benefit from similar technological improvements.

Currently, stainless steel plates are used as electrodes for electrochemical deposition of minerals. Although it is a stable material under the conditions used, it is probably not the most efficient. The two main factors in expanding the use of the above two applications are: 1) reducing the surface area required for electrochemical deposition, and 2) reducing the required current (operational costs) to increase the pH in the water stream. However, the material used must remain available and cheap so that it can be applied on a sufficiently large scale.

### SUMMARY

The present invention describes a combined method for carbon sequestration and water treatment, wherein 1) said carbon sequestration comprises capturing atmospheric carbon dioxide in an aqueous solution, and 2) said water treatment comprises simultaneous removal of said carbon dioxide from said aqueous solution by electrochemical deposition of metal carbonates, hydroxides and/or mixed salts crystallised on crystallisation seeds or beads.

In one embodiment, the water treatment comprises the following steps:
1) Water pumping or streaming through an electrochemical cell, in which a cathode chamber and an anode chamber are separated;
2) Conducting a water splitting reaction by passing electric current between said cathode and said anode, thereby raising pH in the cathode chamber as a result of said water splitting reaction to produce an alkaline stream; and
3) Feeding the alkaline stream produced in Step (2) into a crystallisation chamber containing the crystallisation seeds or beads capable of inducing a crystal growth, thereby depositing said metal carbonates, hydroxides and/or mixed salts in their crystalline form on said crystallisation seeds or beads.

In a particular embodiment, metal carbonates, hydroxides and mixed salts are insoluble or sparingly soluble inorganic compounds or complexes obtained from the captured carbon dioxide by chemical reactions with water and metal cations contained in said pretreated water.

In other embodiments, the electrochemical cell comprises the cathode chamber and the anode chamber separated by a semipermeable membrane serving as a salt bridge.

In a further embodiment, the crystallisation seeds are seeding crystals serving as nucleation centres for crystal growth of the metal carbonates, hydroxides and/or mixed salts from the alkaline stream. The crystallisation seeds are optionally chemically modified with chemical functional groups to provide selective tuneable purity to the crystalline metal carbonates, hydroxides and/or mixed salts crystallised on said seeds.

In a certain embodiment, the beads are polymeric beads structured to induce deposition and crystallisation of metal carbonates, hydroxides and/or mixed salts from the water. The beads are optionally chemically modified with chemical functional groups to provide selective tuneable purity to the crystalline metal carbonates, hydroxides and/or mixed salts crystallised on said beads.

In a specific embodiment, the water pretreated in the method of the present invention is selected from brine, sea water, brackish water, and potable water. Non-limiting examples of the metal cations contained in said pretreated water are calcium and magnesium cations, iron and aluminium. Non-limiting examples of the metal carbonates are calcium carbonate (CaCO₃) and magnesium carbonate (MgCO₃). A mon-limiting example of the mixed salt is basic magnesium carbonate ((MgOH)₂CO₃ or Mg(OH)₂*MgCO₃). Non-limiting examples of the metal hydroxides are calcium hydroxide (Ca(OH)₂), magnesium hydroxide (Mg(OH)₂), iron hydroxides (Fe(OH)₂, Fe(OH)₃) and aluminium hydroxide (Al(OH)₃).

In some embodiments, the method of the present invention is used for descaling, anti-corrosion and biological hazard removal.

In some other embodiment, the method of the present invention further comprises the step of remineralisation, which is releasing the crystalline metal carbonates, hydroxides and/or mixed salts obtained in the method back into water, thereby restoring a mineral content of the treated water or enriching the treated water with minerals.

In still other embodiments, a water stream obtained from the alkaline stream after the precipitation of calcium carbonate and magnesium carbonate in Step (3) is further used for membrane-based water desalination, in cooling towers, or returned directly to water.

In a specific embodiment, CaCO₃-containing minerals and/or MgCO₃-containing minerals are further added to a water stream obtained from the alkaline stream after the precipitation of the metal carbonates, hydroxides and/or mixed salts in Step (3), in order to raise calcium and magnesium levels in said water stream. The resulting stream having the increased calcium and magnesium levels is further released back into the ocean, where it is capable of capturing more carbon dioxide.

In yet further embodiment, the electrodes in the cathode and anode chambers have a low surface area per precipitated and crystallised metal carbonates, hydroxides and/or mixed salts from water. Non-limiting examples of these electrodes used in the method of the present invention are nanostructured electrodes comprising nanoparticles of conductive material deposited on a conductive electrode support, wherein said nanoparticles are characterised by a particle size of about 20.0 nm or less and a particle size distribution having a tuneable standard deviation within the range of approximately ±0.1 nm to ±1.0 nm.

The particle size distribution of the nanostructured electrode is measured with a differential mobility analyser configured to select particle sizes. The tuneable standard deviation is adjusted by tuning a sheath flow rate of a carrier gas in the range of approximately from 1 ml/min to 25 ml/min in said differential mobility analyser, thereby tuning the standard deviation of a Gaussian distribution of the nanoparticle sizes from approximately ±0.1 nm to approximately ±2 nm.

The nanostructured electrodes used in the method of the present invention are produced by a method of spark ablation combined with a differential mobility analyser to produce a particle size distribution having a tuneable standard deviation within the range of ±0.1 nm to ±1.0 nm. Non-limiting examples of the nanoparticles of the nanostructured electrodes are stainless steel nanoparticles. Non-limiting examples of the conductive electrode support is a solid oxide membrane or a stainless steel.

In some specific embodiments, the particle size of said nanoparticles of the nanostructured electrode is about 10 nm or less, or about 5 nm or less.

Various embodiments may allow various benefits and may be used in conjunction with various applications. The details of one or more embodiments are set forth in the accompanying figures and the description below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Disclosed embodiments will be understood and appreciated more fully from the following detailed description taken in conjunction with the appended figures. The drawings included and described herein are schematic and are not limiting the scope of the disclosure. It is also noted that in the drawings, the size of some elements may be exaggerated and, therefore, not drawn to scale for illustrative purposes. The dimensions and the relative dimensions do not necessarily correspond to actual reductions to practice of the disclosure.

FIG. 1 shows a schematic simplified overview of the amount of carbon dioxide oscillating between air, land and the atmosphere in Gt (gigatonne)/y in the carbon cycle.

FIG. 2 is a schematic overview of the mechanisms of electrochemical precipitation of calcium carbonate.

FIG. 3 shows a block diagram including a membrane cell system for electrochemical deposition and a crystallisation chamber, in which the alkaline feedstock comes into contact with calcium carbonate crystals and precipitation begins.

FIG. 4 shows the stainless-steel material and the nanostructured stainless-steel material produced by the spark ablation technique for the creation of a nanostructured electrode of the present invention, respectively.

FIG. 5a shows cyclic voltammograms of a conventional stainless-steel electrode in the electrochemical precipitation of CaCO₃ in synthetic seawater.

FIG. 5b shows cyclic voltammograms of a nanostructured stainless-steel electrode of the present invention in the electrochemical precipitation of CaCO₃ in synthetic seawater.

FIG. 6a shows the comparative cyclic voltammogram of a nanostructured stainless-steel electrode with 9.5% coverage versus the cyclic voltammogram of a conventional stainless-steel electrode (red line) in the electrochemical precipitation of CaCO₃ in synthetic seawater.

FIG. 6b shows the comparative cyclic voltammogram of a nanostructured stainless-steel electrode with 9.5% coverage normalised to 100% coverage versus the cyclic voltammogram of a conventional stainless-steel electrode in the electrochemical precipitation of CaCO₃ in synthetic seawater.

FIG. 7 shows a scanning electron microscopy image of highly pure (>99.99%) CaCO₃ crystals precipitated in the electrochemical precipitation cell in the method of the present invention.

FIG. 8 shows a SEM-EDX image of locational differences in the preferential precipitation of Ca, Mg and (Na)Cl from nearshore Mediterranean seawater using chemically modified crystallisation seeds.

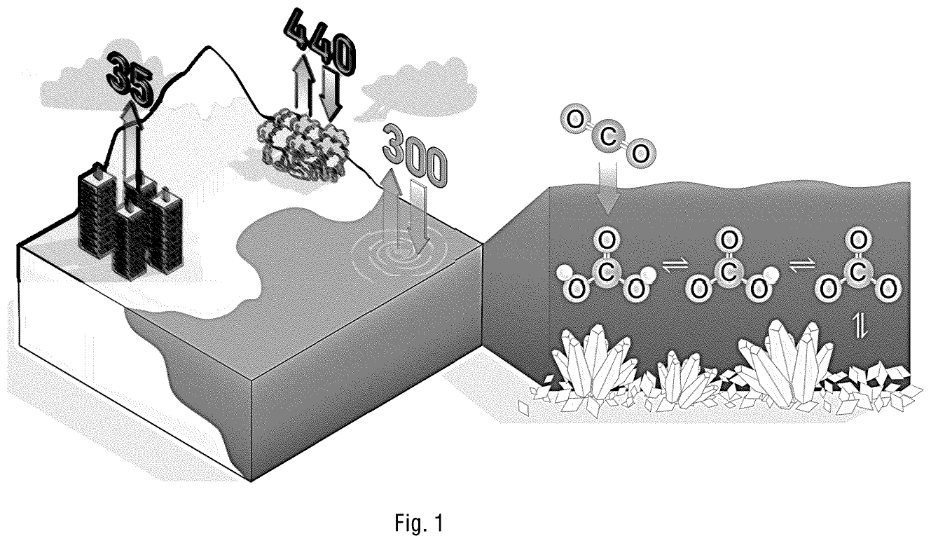

### DETAILED DESCRIPTION

In the following description, various aspects of the present application will be described. For purposes of explanation, specific configurations and details are set forth in order to provide a thorough understanding of the present application. However, it will also be apparent to one skilled in the art that the present application may be practiced without the specific details presented herein. Furthermore, well-known features may be omitted or simplified in order not to obscure the present application.

The term “comprising”, used in the claims, is “open ended” and means the elements recited, or their equivalent in structure or function, plus any other element or elements which are not recited. It should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising x and z” should not be limited to devices consisting only of components x and z. Also, the scope of the expression “a method comprising the steps x and z” should not be limited to methods consisting only of these steps.

Unless specifically stated, as used herein, the term “about” is understood as within a range of normal tolerance in the art, for example within two standard deviations of the mean. In one embodiment, the term “about” means within 10% of the reported numerical value of the number with which it is being used, preferably within 5% of the reported numerical value. For example, the term “about” can be immediately understood as within 10%, 9%, 8%, 7%, 6%, 5%, 4%, 3%, 2%, 1%, 0.5%, 0.1%, 0.05%, or 0.01% of the stated value. In other embodiments, the term “about” can mean a higher tolerance of variation depending on for instance the experimental technique used. Said variations of a specified value are understood by the skilled person and are within the context of the present invention. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges, for example from 1-3, from 2-4, and from 3-5, as well as 1, 2, 3, 4, 5, or 6, individually. This same principle applies to ranges reciting only one numerical value as a minimum or a maximum. Unless otherwise clear from context, all numerical values provided herein are modified by the term “about”. Other similar terms, such as “substantially”, “generally”, “up to” and the like are to be construed as modifying a term or value such that it is not an absolute. Such terms will be defined by the circumstances and the terms that they modify as those terms are understood by those of skilled in the art. This includes, at very least, the degree of expected experimental error, technical error and instrumental error for a given experiment, technique or an instrument used to measure a value.

As used herein, the term “and/or” includes any and all combinations of one or more of the associated listed items. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached to”, “connected to”, “coupled with”, “contacting”, etc., another element, it can be directly on, attached to, connected to, coupled with or contacting the other element or intervening elements may also be present. In contrast, when an element is referred to as being, for example, “directly on”, “directly attached to”, “directly connected to”, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

The present invention relates to a combined method for carbon sequestration and water treatment, wherein 1) said carbon sequestration comprises capturing atmospheric carbon dioxide in an aqueous solution, and 2) said water treatment comprises simultaneous removal of said carbon dioxide from said aqueous solution by electrochemical deposition of metal carbonates, hydroxides and/or mixed salts crystallised on crystallisation seeds or beads.

In some embodiments, said water treatment comprises the following steps:
(1) Water pumping or streaming through an electrochemical cell, in which a cathode chamber and an anode chamber are separated;
(2) Conducting a water splitting reaction by passing electric current between said cathode and said anode, thereby raising pH in the cathode chamber as a result of said water splitting reaction to produce an alkaline stream; and
(3) Feeding the alkaline stream produced in Step (2) into a crystallisation chamber containing the crystallisation seeds or beads capable of inducing a crystal growth, thereby depositing said metal carbonates, hydroxides and/or mixed salts in their crystalline form on said crystallisation seeds or beads.

In other embodiments, said metal carbonates, hydroxides and mixed salts are insoluble or sparingly soluble inorganic compounds or complexes obtained from the captured carbon dioxide by chemical reactions with water and metal cations contained in said pretreated water.

In still other embodiments, said electrochemical cell comprises the cathode chamber and the anode chamber separated by a semipermeable membrane serving as a salt bridge.

In a further embodiment, the crystallisation seeds are seeding crystals serving as nucleation centres for crystal growth of the metal carbonates, hydroxides and/or mixed salts from the alkaline stream.

In yet further embodiment, the crystallisation seeds are chemically modified with chemical functional groups to provide selective tuneable purity to the crystalline metal carbonates, hydroxides and/or mixed salts crystallised on said seeds. In a specific embodiment, polymeric beads are used instead of crystallisation seeds to induce deposition and crystallisation of metal carbonates, hydroxides and/or mixed salts from the water.

The traditional water treatment method is to add antiscalants to the water. This is harmful to the environment and requires high operating costs. The electrochemical method of the present invention uses only renewable electricity (which is very energy efficient) and thus not only eliminates the use of harmful chemicals in the water, but also captures additional carbon dioxide from the treated water.

In a particular embodiment, all types of water can be used in the method of the present invention. Non-limiting examples of water treated in the method of the present invention are brine, sea water, brackish water, and potable water. This is the first advantage of the method of the present invention over the aforementioned known ocean-based carbon capture methods. Further, in contrast to other ocean-based carbon capture methods, the method of the present invention also uses various metal cations contained in the pretreated water for carbon capture. Thus, the carbon is captured in the crystalline form of various insoluble or sparingly soluble metal carbonates, hydroxides and/or mixed salts, thereby increasing the carbon capture potential of the method per unit of water about four times relative to other methods based exclusively on precipitation of calcium carbonate. Non-limiting examples of said metal cations contained in said pretreated water are both calcium and magnesium cations, iron and aluminium. Non-limiting examples of insoluble or sparingly soluble metal hydroxides are calcium hydroxide (Ca(OH)₂), magnesium hydroxide (Mg(OH)₂), iron hydroxides (Fe(OH)₂, Fe(OH)₃) and aluminium hydroxide (Al(OH)₃). Non-limiting examples of insoluble or sparingly soluble metal carbonates are calcium carbonate (CaCO₃) and magnesium carbonate (MgCO₃). Non-limiting example of an insoluble or sparingly soluble mixed salt is basic magnesium carbonate ((MgOH)₂CO₃ or Mg(OH)₂*MgCO₃).

There are three benefits for water treatment are offered by the method of the present invention over currently applied processes (which all require separate additions of chemicals in the currently applied water treatment processes): descaling, anti-corrosion and biological hazard removal. These are all achieved in the method of the present invention by the addition of (renewable) electricity thereby becoming a carbon-negative process.

### Calcium

Precipitated calcium compounds, for example CaCO₃, from the above described methods are used or stored in such a way that CO₂ is not re-released back into the air. In other words, CaCO₃ is not to be used for cement production where CO₂ is released again.

Calcium carbonate (CaCO₃) has a variety of market applications, some of the most common include:
1) Construction materials: Calcium carbonate is used as a filler in many construction materials such as concrete, paint, and plastics. It is also used in the manufacturing of cement, lime, and glass.
2) Agriculture: Calcium carbonate is used as a soil amendment to increase the pH levels of acidic soils and to provide plants with the calcium they need for healthy growth.
3) Pharmaceuticals: Calcium carbonate is used as a dietary supplement and an antacid.
4) Food industry: Calcium carbonate is used as a food additive to improve the texture and consistency of products, as well as to provide essential nutrients to consumers.
5) Paper industry: Calcium carbonate is used as a filler in the paper industry to improve the smoothness and whiteness of the paper.
6) Chemical industry: Calcium carbonate is used in chemical industry as a source of calcium and carbonate ions and in production of various chemical compounds like Calcium Oxide, Calcium Hydroxide etc.
7) Personal care industry: Calcium carbonate is used as a mild abrasive in toothpastes and as a thickening agent in cosmetics.
8) Plastics industry: Calcium carbonate is used as filler in plastic products to lower the cost and increase the stiffness and impact resistance.

These are some of the most common market applications of calcium carbonate, but new uses for the material are continually being developed and explored. High purity calcium carbonate such as used in the food industry and for pharmaceuticals requires >99.99% pure calcium carbonate, which is difficult to obtain via traditional mining methodologies and is a growing market.

### Magnesium

Magnesium ions play an important role in drinking water as they contribute to the overall mineral content and can provide various health benefits. Magnesium is essential for proper muscle and nerve function, as well as the metabolism of nutrients in the body.

The concentration of magnesium ions in seawater is relatively high, with an average of around 1,300 mg/L. This is significantly higher than the concentration of magnesium ions found in freshwater sources, which typically range from 30-150 mg/L. The high concentration of magnesium ions in seawater is due to the many dissolved minerals, specifically magnesium compounds such as magnesium chloride and magnesium sulfate. The concentration of magnesium ions in seawater can vary depending on location and the surrounding geology, but it is generally considered to be a stable and consistent source of magnesium. The high concentration of magnesium ions in seawater also plays a role in ocean chemistry and marine ecosystems, influencing the growth and behavior of various aquatic organisms.

Magnesium carbonate precipitation is a process in which magnesium ions in water react with carbonate ions to form solid magnesium carbonate. This process can occur naturally in both surface and ground water sources and can be triggered by a number of factors, including changes in pH, temperature and the presence of other dissolved minerals. However, precipitation is kinetically inhibited due to the strong hydration of magnesium (Mg²⁺) ions in solution. Therefore, it seems that at ambient temperatures, MgCO₃ growth and crystallisation is limited by very slow reaction rates and despite the fact that it is a very stable structure it is very difficult to induce crystalisation.

Theoretically, there are a number of ways to try and overcome this hindrance. Firstly, and the most straightforward way is to increase the activity of magnesium and carbonate species by concentrating these compounds in solution (Mg concentrated water or adding CO₂ for example). Secondly, decreasing the activity of Mg ions by adding complexing compounds. One can also reduce water activity. Lastly, changing the environmental conditions such as temperature can also affect the kinetics of the precipitation process.

Alternatively, Mg(OH)₂ precipitation, which is a process where magnesium ions in water react with hydroxide ions to form solid magnesium hydroxide, can also be used as a step in carbon sequestration method. This process can occur naturally in both surface and ground water sources, and is often used as a treatment method for water containing high levels of magnesium ions, such as the limesoda ash softening process which is widely used to remove both Ca²⁺ and Mg²⁺ hardness from water in the form of CaCO₃ and Mg(OH)₂ respectively. The precipitate can later be used for dehydroxylation and carbonation reactions to create magnesium carbonate products either in aqueous or autoclave processes.

Precipitation of magnesium carbonate is generally considered to be more difficult than precipitation of calcium carbonate for several reasons:
1) Kinetics: The rate of the precipitation reaction for magnesium carbonate is generally slower than that of calcium carbonate, which can make it more difficult to achieve high yields of the precipitate.
2) Thermodynamics: The precipitation of magnesium carbonate is a less thermodynamically favorable process than that of calcium carbonate. The Gibbs free energy change for the reaction of magnesium carbonate is higher than that of calcium carbonate, which means that it is less likely to happen on its own.

All in all, the precipitation of magnesium carbonate is more difficult than that of calcium carbonate due to the lower reactivity of magnesium carbonate and the higher energy required for the precipitation reaction. As the Mg weight content in seawater is roughly four times higher by weight than that of Ca, the potential of capturing carbon with it is much higher, but current methods do not describe Mg removal, as it is not an easy pH switch like with Ca.

The system discussed here, takes a magnesium-rich effluent after the CaCO₃ precipitation step/during the CaCO₃ precipitation step and induce a second/parallel precipitation of Mg(OH)₂ to achieve high amounts and high efficiency of carbon removal from seawater (which will then be converted to magnesium carbonate products).

### Desalination

Water desalination, the process of removing salt and other minerals from seawater to make it potable, is becoming an increasingly important solution to address the growing global water scarcity. The market for desalination is projected to grow significantly in the coming years, driven by factors such as population growth, urbanization, and climate change. The use of desalination technology is expected to increase in both developed and developing countries, with the Middle East, North Africa, and Asia Pacific regions expected to experience the highest growth. The market is also projected to be driven by advances in technology, such as the development of more energy-efficient and cost-effective desalination methods. Overall, the global desalination market is expected to reach USD 34.8 billion by 2028, growing at a CAGR of 6.1% during the forecast period.

Desalination of seawater (market worldwide 7B USD) provides many countries in the world with their own potable water supply, done mainly by the reverse osmosis (RO) process. To prevent scaling and fouling from for example calcium-containing mineral deposits on the reverse osmosis (RO) membranes, the water is chemically pretreated.

### Pretreatment for Water Desalination

There are several methods that are currently used to pretreat seawater before the reverse osmosis (RO) process takes place. These include:
1) Screening: Seawater is passed through screens to remove large debris such as seaweed, shells, and plastic.
2) Coagulation/Flocculation: Chemicals such as alum or ferric chloride are added to the seawater to cause small particles to clump together, making them easier to remove.
3) Sedimentation: The clumped particles settle to the bottom of a tank, where they can be removed.
4) Filtration: The seawater is passed through filters to remove smaller particles, such as suspended solids and bacteria.
5) Disinfection: The seawater is treated with disinfectants, such as chlorine or ultraviolet light, to kill any remaining bacteria or other microorganisms.
6) pH adjustment: It involves adding acid or base to bring the seawater to an optimal pH range for the reverse osmosis membrane.
7) Pretreatment membrane filtration: It includes microfiltration, ultrafiltration, and nanofiltration. These are membrane-based technologies which can help to remove suspended solids, microorganisms, and dissolved organics.

These pretreatment steps are essential to protect the reverse osmosis membrane, extend its lifespan, and improve the overall efficiency of the desalination process.

Scale deposits can readily form on flow surfaces when a solution is concentrated beyond the solubility limit of a dissolved sparingly soluble salt or when a solution containing an inverse solubility salt is in contact with a hot surface. Such conditions are met in both thermal and membrane desalination processes.

Scale deposition cannot be tolerated because of its highly deleterious effects on production capacity and specific energy consumption. The usual scale control method applied in water desalination is based on the dosage of inhibiting compounds which can suppress scale precipitation up to a certain degree. The maximum water recovery level that can be achieved in brackish water desalination is governed by the scale suppression capability of anti-scalants (e.g., PAMAM dendrimer, generation 1 and 2, and polymer PEI).

For prevention of scaling and fouling on RO membranes, the salty or brackish water is generally chemically pretreated. This happens through the addition of antiscalants in order to inhibit precipitation of metal carbonates, hydroxides and/or mixed salts, for example calcium carbonate and magnesium hydroxide. The antiscalants are added in approximately 5 mg/l of water (depending on the feed water hardness).

The antiscalants have both high operational costs and they are environmentally unfriendly, as their production alone creates significant greenhouse gases emissions of about 10,000 tons CO₂ eq per year/ton antiscalant. Moreover, brine containing high concentrations of these antiscalants is considered a hazard to marine life and the environment due to the presence of phosphorous- and nitrogen-containing chemical groups in these compounds, which are present in most antiscalants. These chemical groups causes effects on the biogeochemical flows through effects called eutrophication and nitrification. In addition, some modern desalination techniques that are being developed, such as capacitive deionisation, can potentially not be pretreated by antiscalants due to the operational characteristics of such systems.

### Descaling of Water

Scale deposition and buildup is a problem that can, in general, be encountered in places where large amounts of water flows are used for various end goals. For example, in wet cooling towers, or in residential use in areas with relatively high salt concentrations in drinking water. This scale deposition can be so severe that it can affect the structural integrity of buildings or reactors or can simply affect the taste and texture of residential drinking water. In wet cooling towers, especially in industrial use, the use of descaling methods is a necessity. For example, the concentration of antiscalants in cooling tower water is about 8 times higher (˜40 mg/L) than the use in desalination practices due to the operational characteristics of cooling towers.

Descaling of water for cooling towers is the process of removing mineral buildup, such as calcium carbonate and magnesium carbonate, from the water used in the cooling tower. There are several methods that can be used to descale water for cooling towers, including:
1) Chemical treatment: This method involves adding a chemical descaling agent, such as phosphonic acid or citric acid, to the water to dissolve the mineral buildup.
2) Electrolytic treatment: This method uses an electric current to dissolve the mineral buildup.
3) Mechanical treatment: This method uses physical means to remove the mineral buildup, such as using a high-pressure water jet or a brush.
4) Reverse osmosis: This method uses a membrane to filter the mineral buildup out of the water.
5) Dispersant treatment: This method involves adding a dispersant chemical to the water to keep the minerals suspended, preventing them from depositing on surfaces.

The most appropriate method for a specific cooling tower will depend on the type of mineral buildup, the water chemistry, and the design of the cooling tower. Chemical treatment is a common method used in industrial and commercial cooling towers, while reverse osmosis is more commonly used in smaller, residential cooling towers. In addition, it is important to have routine monitoring and maintenance of cooling tower water chemistry, to prevent scaling and corrosion.

### Combined Method of the Present Invention

One of the major aspects of the present invention is a combination of carbon sequestration and water treatment, where both processes are carried out simultaneously. The carbon sequestration involves capturing and storing atmospheric carbon dioxide in an aqueous solution, while simultaneous water treatment involves removal of the captured carbon dioxide from this aqueous solution by electrochemical deposition of metal carbonates, hydroxides and/or mixed salts crystallised on crystallisation seeds or beads.

It is clear from the above description that the ability to control the precipitation of metal carbonates, hydroxides and/or mixed salts in water can be of huge benefit. Electrochemical scale removal offers many advantages: environmental compatibility, no need to handle and dose chemicals, accessibility to automation and convenient process control.

An alternative to antiscalants is electrochemical precipitation, which is performed via tuning or adjusting of the pH level of water that is to be treated, thus forcing the pH-dependent precipitation of the metal carbonates, hydroxides and/or mixed salts.

Electrochemical scale removal offers many advantages for pretreatment of water: environmental compatibility, no need to handle and dose chemicals, accessibility to automation and convenient process control. While this methodology has the potential to have very low operational costs, and will overcome the antiscalant issue, industrial application is generally hindered by low activity electrodes, and the consequent high operational costs (electricity), and high capital costs (large electrode areas need to be available due to the low overall activity).

As discussed above, the solubility of carbon dioxide in water depends on the pH level, the higher the pH the more CO₂ can be dissolved in water. Furthermore, there is a negative correlation in the solubility of the metal carbonates, hydroxides and/or mixed salts with pH. In other words, the higher the pH, the more metal carbonates, hydroxides and/or mixed salts will precipitate. While this is an issue for the ocean alkalinity enhancement (OAE) methodology described above, as a runaway precipitation removes more alkalinity than added by dissolving quicklime, the electrochemical precipitation can take advantage of these consequences.

In the present invention, the electrochemical precipitation of metal carbonates, hydroxides and/or mixed salts is carried out as a water treatment methodology before e.g. membrane-based desalination occurs, or for descaling. By creating a higher pH locally around the electrode by the splitting of water, the precipitation of metal carbonates, hydroxides and/or mixed salts is induced.

O₂+2H₂O+4ē→OH⁻

2H₂O+ē→H₂+2OH⁻

Ca²⁺+HCO₃⁻+OH⁻→CaCO₃+H₂O

One of the factors limiting the use of electrochemical precipitation-based water treatment is that the metal carbonates, hydroxides and/or mixed salts precipitates onto the working electrode, which causes a very high specific electrode area requirement. As a result, the precipitate should be periodically removed, and many other additional issues arise due to this buildup of precipitate onto the cathode. The nominal precipitation rate in such a fashion would be around 50 g CaCO₃/h/m², for example. This is a very well-known problem in the field, and there is a long-felt need to solve this problem.

The present inventors surprisingly found that this problem can be unexpectedly solved by using electrochemical crystallisation of the metal carbonates, hydroxides and/or mixed salts induced by crystallisation seeds as a treatment for water desalination together with capturing carbon dioxide. The integration and optimisation of this combined process means that the present invention is actually killing two birds with one stone. In other words, water is treated for desalination by capturing carbon dioxide from the air and removing it from the atmosphere.

In addition, it should be noted that the electrochemical scale removal is currently applied only to calcium-containing compounds. No other metal cations, such as magnesium, are used for this purpose, thus losing four times by weight its CO₂ capture potential, and requiring additional steps for water treatment. Also, returning the treated stream back into the ocean can be detrimental for ocean life, limiting its scalability, and is not well studied. Further, calcium carbonate is currently precipitated directly on electrodes. Moreover, the current electrochemical scale removal requires large surface area electrodes and high overpotentials.

All these issues are successfully overcome by the method of the present invention based on the combination of the integrated water treatment and carbon sequestration as a net negative carbon capture process. The method of the present invention uses a low electrode-surface area per precipitated and crystallised minerals from water. The present inventors found that the use of the low electrode-surface area unexpectedly results in a net-negative carbon dioxide emissions process, particularly when using renewable electricity.

Moreover, the method of the present invention further allows to subsequently release the crystalline metal carbonates, hydroxides and/or mixed salts obtained in the method back into water. This process is called remineralisation and it is an important step in desalination because it helps to restore the mineral content of the water that has been treated by the desalination process. During the process of desalination, minerals are removed along with the salt and other impurities from the water. This can result in water that is low in essential minerals, such as calcium, magnesium and iron, which are important for human diet and health. Remineralisation involves adding the necessary minerals back into the water to ensure that the potable water is healthy for consumption. This step is particularly important for people who rely on desalinated water as their primary source of potable water.

Electrochemical remineralisation of potable desalinated water coupled with CO₂ capture is a process that enables the enrichment of calcium, magnesium and iron cations through the corresponding metal-based minerals obtained by electrochemical decomposition according to the process described in the present invention. The metal carbonates are transformed into carbon dioxide via the carbonate system. These minerals are dissolved in the acidic environment that is formed on the anodic compartment through the water-splitting process, which enables CO₂ capture in pure, gaseous form.

Another essential aspect of the present invention is the use of the crystallisation seeds or beads or seeding nuclei in electrochemical crystallisation to obtain insoluble and sparingly soluble carbonates, hydroxides and/or mixed metal salts in their crystalline (rather than amorphous) form in the method of the present invention. These seeding crystals or beads increase the carbon capture potential by more than three times per unit of treated water.

Non-limiting examples of the crystallisation seeds of the present invention comprise calcium carbonate in the form of the CaCO₃-containing minerals, for example, aragonite or vaterite, magnesium carbonate in the form of the MgCO₃-containing minerals, for example magnesite, barringtonite, nesquehonite, artinite, hydromagnesite, dypingite, and lansfordite. The seeds can be used as obtained, or with an additional high temperature calcination step in any oxidising gaseous environment, for example 22% 02 in inert, or reduction step in a reducing environment and elevated temperature, for example, CO at 300° C. The chemical purity of the seeds is 98-99.999%.

Additionally, the seeds comprise high surface area solids, for example high surface area carbon, high surface area n-doped carbon obtained by a pyrolysis of biomaterial, silica, alumina, titania, or polymer microspheres which have been chemically functionalised. Chemical functionalisation is carried out through, for example, carboxylation processes like prolonged alkaline hydrolysis. The diameter of the seeds as measured by optical microscopy is between 200 m (micron) and 5 mm. After growth to maximum 5 mm, the seeds are removed from the electrochemical precipitation cell.

The exemplary electrochemical precipitation cell used in experiments carried out for the development of the present invention is designed to operate at speeds of between 60 to 100 m/hr. The hydraulic resistance is designed to be kept between 16.2 and 16.9 kPa.

Non-limiting examples of electrodes having low electrode-surface area used in the present invention are nanostructured electrodes described in the co-pending patent application by the same inventors, which is incorporated by reference in its entirety in the present application.

The nanostructured electrodes that can be used in the method of the present invention comprise nanoparticles of conductive material deposited on a conductive electrode support, said nanoparticles are characterised by a particle size of about 20.0 nm or less and a particle size distribution having a tuneable standard deviation within the range of approximately ±0.1 nm to ±1.0 nm. These nanostructured electrodes are manufactured by the method of spark ablation, which provides a scalable and viable way for producing widely different types of mixed nanoparticles. The addition of a differential mobility analyser to the electrode production setup provides the opportunity to select a sharp particle size distribution, where the term “sharp” means that the particle size distribution is within a standard deviation between ±1 nm and ±0.1 nm. Most importantly, implementation of the spark ablation has the great advantage to combine a wider range of materials, thereby allowing the synthesis of mixed nanoparticles with virtually unlimited combinations. The present invention is not limited to particular electrodes or particular materials of the electrodes though.

Non-limiting examples of the materials used in the exemplified nanostructured electrodes are yttrium (Y), yttria-stabilized zirconia (YSZ), zirconium (Zr), nickel (Ni), copper (Cu), platinum (Pt), lanthanum strontium manganite (LSM), praseodymium-doped ceria (PrCeO₂), gadolinium-doped ceria (GdCeO₂), samarium-doped ceria (SmCeO₂), neodymium-doped ceria (NdCeO₂), erbium-doped ceria (ErCeO₂), lanthanum strontium cobaltite (LSC), lanthanum strontium cobalt ferrite (LSCF) and stainless steel. The specific example of the aforementioned nanostructured electrodes, is a nickel-impregnated yttria-stabilized zirconia (Ni@YSZ) electrode or stainless steel electrode, both are produced by the method of spark ablation.

As defined herein, the term “tuneable” with respect to the aforementioned standard deviation means that by altering the sheath flow rate of the carrier gas in the range of approximately 1 ml/min to 25 ml/min in the differential mobility analyser, which selects the particle sizes, the standard deviation of the Gaussian distribution of nanoparticle sizes is tuned from approximately ±0.1 to ±2 nm. Another parameter affecting the standard deviation of the Gaussian distribution of nanoparticle sizes that evolve from the differential mobility analyzer, is the type of inert gas that is used as the aerosol carrier gas, e.g., Ar, versus N₂.

In one embodiment, said conductive material of the nanoparticles produced in the spark ablation process is selected from yttrium (Y), zirconia (Zr), zirconia stabilised with yttrium (YSZ), nickel and stainless steel. In a particular embodiment, said nanoparticles are nickel-impregnated yttria-stabilized zirconia (Ni@YSZ) composite nanoparticles. In another specific embodiment, said nanoparticles are stainless steel nanoparticles. In some embodiments, the conductive electrode support is a solid oxide membrane. In other embodiments, the particle size of the nanoparticles is about 10 nm or less, or about 5 nm or less.

### EXAMPLES

It is clear from what is described above that the ability to control salt deposition in water can be very useful. Electrochemical descaling has many advantages: environmental friendliness, no need for handling and dosing of reagents, automation and convenient process control.

As discussed above, the solubility of carbon dioxide in seawater is pH dependent: the higher the pH, the more CO₂ can be dissolved in seawater. In addition, there is a negative correlation between CaCO₃ solubility and pH. Or, in other words, the higher the pH, the more CaCO₃ will precipitate. Although this is a problem for the OAE methodology described above, since uncontrolled calcium carbonate precipitation removes more alkali than is added by dissolving quicklime, electrochemical precipitation can exploit this effect.

Calcium carbonate electrochemical precipitation can be used as a water pre-treatment method, for example, before membrane desalination or for descaling. By splitting water and thus, increasing the pH locally around the electrode, precipitation of CaCO₃ is induced, as indicated in the following chemical equations:

O₂+2H₂O+4ē→OH⁻

2H₂O+2e⁻→H₂+2OH⁺

Ca²⁺+HCO₃⁻+OH⁻→CaCO₃+H₂O

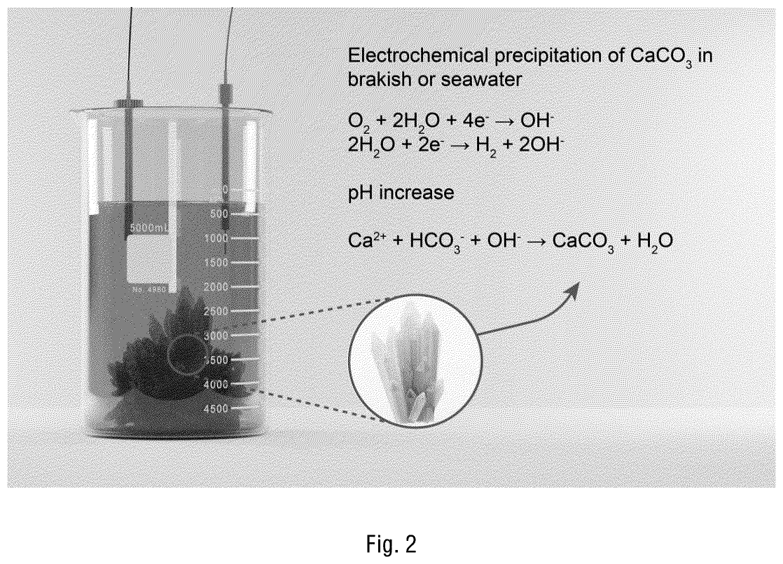

FIG. 2 schematically represents the idea of electrochemical deposition, if it were carried out in the schematically depicted manner, then the main factor preventing its use would be that calcium carbonate is deposited on the working electrode, which requires a very high specific area of the electrode. In addition, precipitates must be periodically removed, and the accumulation of the precipitates on the cathode is associated with many other additional disadvantages. The nominal precipitation rate for this method is about 50 g CaCO₃/h/m².

The main barriers to applying the aforementioned electrochemical precipitation includes the CaCO₃ deposition on electrodes, requirement for large electrode surface area (capital cost) and for high overvoltages (maintenance costs).

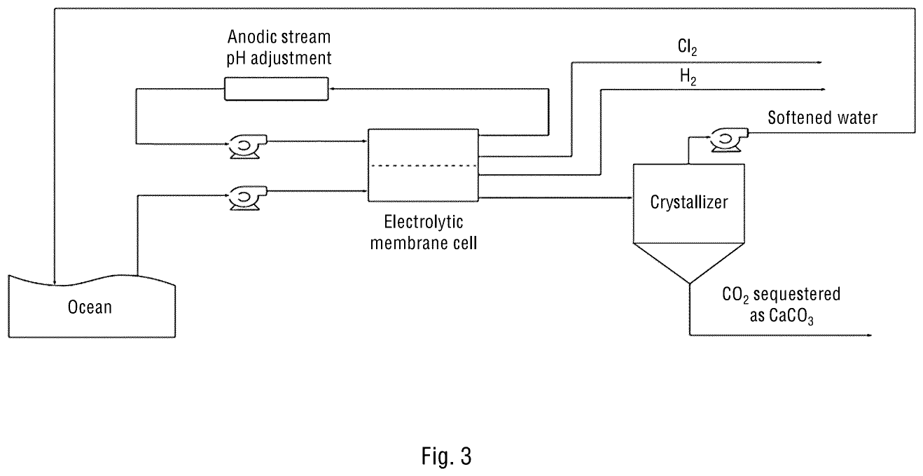

Reference is now made to FIG. 3 showing the scheme of the electrochemical deposition process with a calcium carbonate seed system. Sea water is pumped through an electrochemical precipitation cell, in which the cathode and anode compartments are separated. By creating a higher pH in the cathode chamber due to the water splitting reactions described above and feeding this alkaline stream into the crystalliser where CaCO₃ seeds are present, the CaCO₃ in the sea water is precipitated. Depending on the desired application, either this pre-treated water is used further, for example for membrane-based water desalination, or the descaled water can be used directly, for example in cooling towers. Alternatively, in a carbon sequestration scenario, the alkaline feedstock could either be returned directly to the seawater, or calcium levels could be raised again by adding quicklime before the stream is released back into the ocean, where it captures more carbon dioxide.

Of course, it follows from the above explanation that the use of electrochemical precipitation of CaCO₃ as a pre-treatment for water desalination captures CO₂. Integration and optimisation of this process, for example, with Israeli desalination plants, could mean that two birds are killed with one stone. That is, water is pre-treated for desalination and CO₂ is captured from the air and sequestered simultaneously. Precipitated calcium carbonate should be used or stored in such a way that it cannot be released back into the air. That is, it cannot be used for the production of cement, where CO₂ is released again. The following stream table shows calculating the amount of seawater, which is required to capture 1 kiloton/year of CO₂ via electrochemical CaCO₃ precipitation:

EPS Stream Table

| | | | Cathodic | Anodic | CaCO₃ | |
|---|---|---|---|---|---|---|
| | Sea water 1 | Sea water 2 | stream | stream | stream | Soft water |
| Mass Flow [ton/year] | 9995852 | 9995852 | 9995852 | 9995852 | 4127 * | 9991725 |
| Inorganic Carbon | 0.0276 | 0.0495 | 0.0495 | — | — | |
| Composition [g/kg] | | | | | | 0 ** |
| CO₂ sequestered | — | — | — | — | — | — |
| [ton/year] | | | | | | |
| Temperature [° C.] | 25 | 25 | 25 | — | 25 | — |

* Production per year.
** Assuming max precipitation.

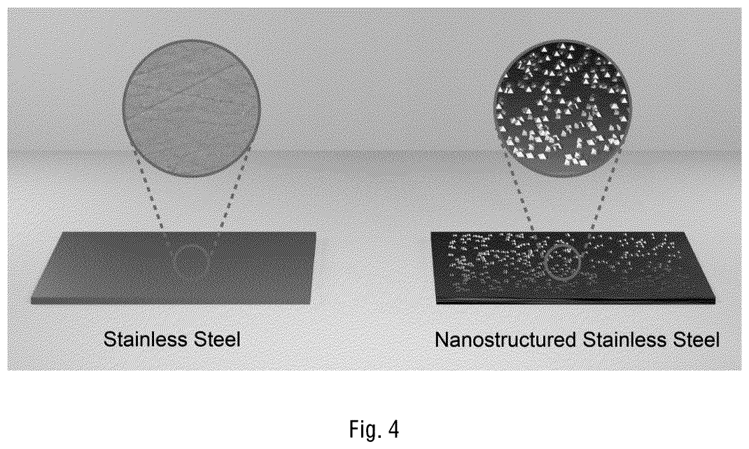

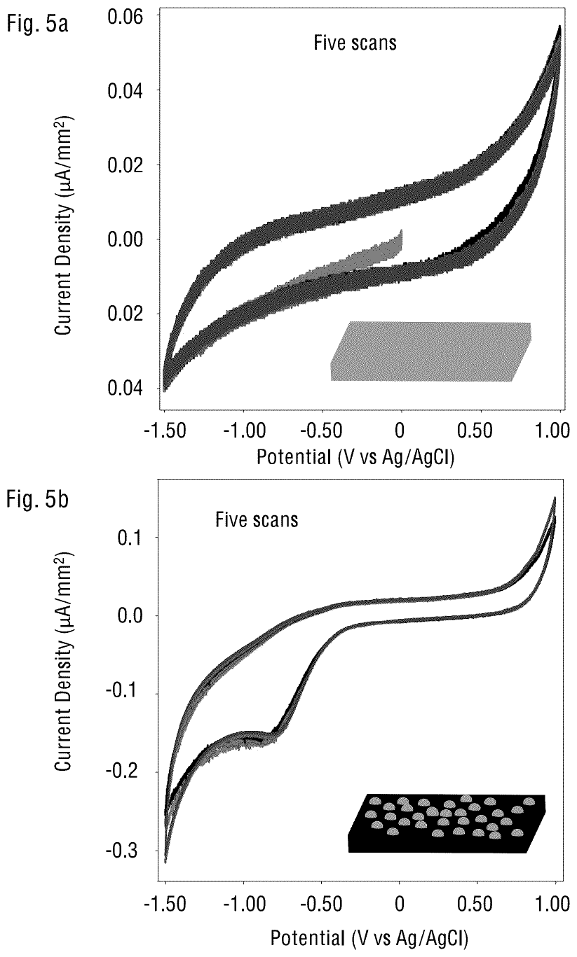

As large amounts of water should be processed via electrochemical precipitation, highly active electrodes must be used in order to achieve low operational costs (electricity costs). Electrochemical precipitation can be achieved with known, highly active electrodes such as Pt or stainless steel. FIG. 4 shows the stainless-steel material and the nanostructured stainless-steel material produced by the spark ablation technique for the creation of a conventional stainless-steel electrode. FIG. 5a shows cyclic voltammograms of a conventional stainless-steel electrode in the electrochemical precipitation of CaCO₃ in synthetic seawater.

High current densities of hundreds of mA/mm² are obtained for the electrochemical precipitation of CaCO₃ in synthetic seawater using Pt as electrodes. Such activities are highly desireable, and perhaps even necessary, in order for electrochemical precipitation as pretreatment for desalination of water to be economically viable, thereby facilitating the viability of carbon capture. Nevertheless, the obvious downside of the use of Pt, and other typically used highly active electrodes is their extremely high cost. For this reason, stainless steel has been the preferred electrode material of choice for electrochemical precipitation. The activity of stainless steel is however very low (as seen in FIG. 5a).

FIG. 4 schematically shows the nanostructured stainless-steel material produced by the spark ablation technique for the creation of a nanostructured electrode of the present invention. As described above, this electrode has one application in electrochemically enhanced precipitation of minerals in water. By nano structuring this typical cathode material, stainless steel, using the spark ablation technology, the initial potential required for water splitting is reduced. The method of the present invention requires even less total energy to increase alkalinity and subsequent electrochemical precipitation of the metal carbonates, hydroxides and/or mixed salts. The benefits of this method are significant improvement in activity, less material required, less surface area required, less electrical power required, highly customisable. FIG. 5b shows cyclic voltammograms of this nanostructured stainless-steel electrode of the present invention in the electrochemical precipitation of CaCO₃ in synthetic seawater as will described below.

### Preparation of Synthetic Sea Water

Nearshore seawater was collected from the Mediterranean ocean. Synthetic sea water was prepared according to literature via the following procedure. A volumetric flask was filled with approximately 850 mL of demineralised water, 2.922 g of NaCl, 0.881 g of CaCl₂·2H₂O, 0.578 g of NaHCO₃ (all analytical purity, Sigma-Aldrich). Fill up volumetric flask to 1 L with demineralised water.

### Electrochemical Activity Measurements of the Nanostructured Stainless-Steel Electrodes

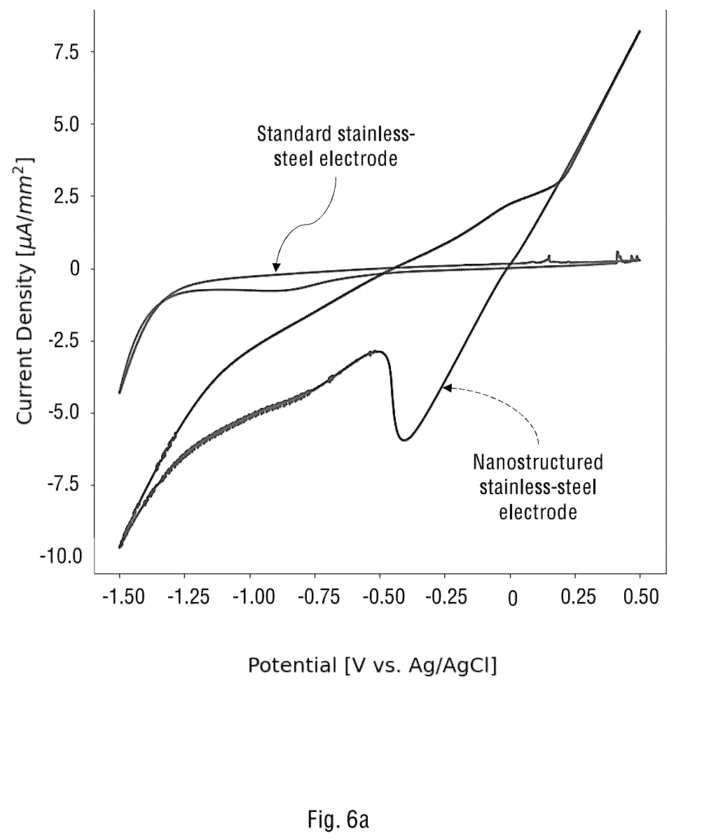

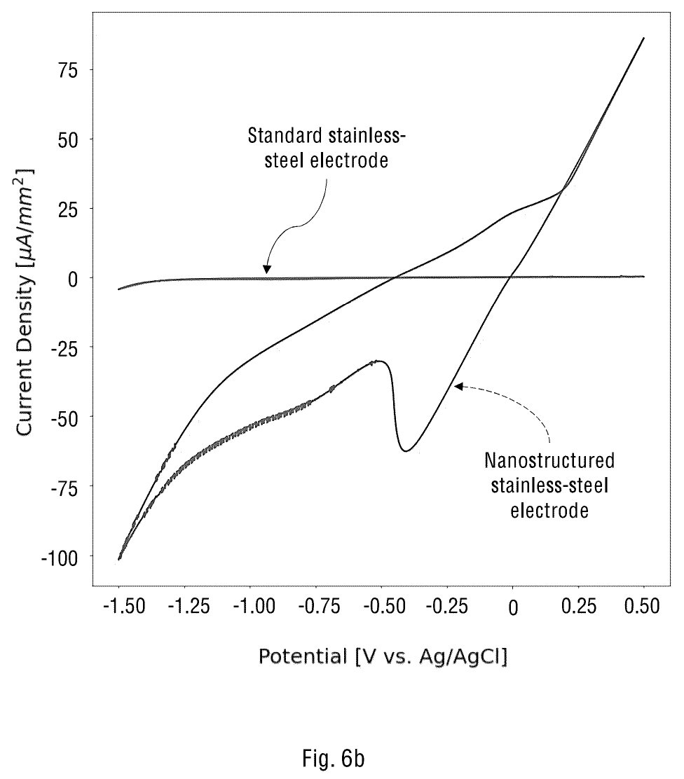

The nanostructured stainless-steel electrode prepared as described above was tested for electrochemical activity by electrochemical deposition of CaCO₃ in synthetic seawater. Reference is now made to FIGS. 5a and 5b showing cyclic voltammograms of a conventional stainless-steel electrode (FIG. 5a) and the new nanostructured electrode of the present invention (FIG. 5b), prepared by the method of spark ablation, respectively, in synthetic seawater containing a mixture of various compounds including NaCl, MgO and Ca(OH)₂. FIG. 6a shows the comparative cyclic voltammogram of a nanostructured stainless-steel electrode with 9.5% coverage versus the cyclic voltammogram of a conventional stainless-steel electrode in the electrochemical precipitation of CaCO₃ in synthetic seawater. FIG. 6b shows the comparative cyclic voltammogram of a nanostructured stainless-steel electrode with 9.5% coverage normalised to 100% coverage versus the cyclic voltammogram of a conventional stainless-steel electrode in the electrochemical precipitation of CaCO₃ in synthetic seawater.

There is a clear improvement in current density with the nanostructured electrode of the present invention, which is a direct indication of the rate of reaction at −0.8 V compared to Ag/AgCl. The current density for the conventional stainless-steel electrode at −0.8 V is −0.018 μA/mm², and for the nanostructured electrode, the current density is −0.19 μA/mm² under the same conditions. This is an order of magnitude improvement.

However, it should be noted that the electrochemical current (activity) of the electrodes is normalised to the area of the electrochemically active surface, equal to 3 mm². In the case of a nanostructured electrode, the conductive electrode support, which is glassy carbon in the present example, was coated with a composition imitating stainless steel, inactive with respect to the described reactions. Thus, when the surface is completely covered with nanostructured stainless steel, the current density will be much higher, and the amount of material for the manufacture of electrodes that will be required will be at least 100,000 times less.

Table 1 below describes some of the parameters of the CaCO₃ electrochemical precipitation process using the current standard as a starting point, as well as the electrochemical improvements described for evaluating CO₂ emission reductions and using this procedure as a carbon sequestration methodology.

TABLE 1
Calculations of rate, cost and emission improvements based on a nanostructured electrode
for electrochemical precipitation of calcium carbonate.

| | | | Assumed rate | |
|---|---|---|---|---|
| Industrial price | | | with propitery | |
| of electricity | | | electrode | |
| [USD/kWh] | | Current | technology | |
| 0.066 | | standard | improvment | |
| CO₂ emissions | Calcium Carbonate rate of | 11.2 | 957.6 | |
| [tonCO₂/kWh] | production [ton/year*m²] | | | |
| 0.000496 | | | | |
| | Energy consumption | 6000 | 625 | |
| | [kWh/tonCaCO₃] | | | |
| | Energy cost per 1kton of CO₂ | 898.9 | 18.15 | Note: it is assumed that |
| | precipitated [USD/tonCO₂] | | | the most substantial |
| | | | | amount of energy is |
| | | | | consumed in |
| | | | | electrochemical cell. |
| | Electrode area needed for | 202678.6 | 2371 | |
| | sequestrering 1 kton of CO₂ [m²] | | | |
| | CO₂ emissions based on the | 2.98 | 0.31 | Note: based on the |
| | energy consumption | | | assumption that the |
| | [tonCO₂/year*tonCaCO₃] | | | electricity usage if |
| | | | | from the main grid. |
| | CO₂ emissions reduction based | — | −2.67 | |
| | on our improvments | | | |
| | [tonCO₂/year*tonCaCO₃] | | | |

Table 2 below shows exemplary values for the method of the present invention:

| Description | Value |
|---|---|
| Amount of CO₂ sequestered per m³ water treated | 0.45 [kgCO₂/m³] |
| Energy consumption per m³ water treated | 0.12 [kWh/m³] |
| Energy consumption per ton CO₂ sequestered | 275 [kWh/tonCO₂] |
| Electricity cost per ton CO₂ sequestered | 18.15 [USD/tonCO₂] |
| Electricity cost per m³ water treated | 0.0079 [USD/m³] |
| Antiscalant cost per m³ water treated | 0.0075 [USD/m³] ** only substance-not |
| | including labor costs etc. |

### Electrochemical Crystallisation

Using electrode materials, which are more active than stainless steel, but resistant to seawater, such as Pt-containing single atom catalysts on C sheets, or the aforementioned nanostructured stainless steel, outputs for CaCO₃ precipitation can be achieved as described above.

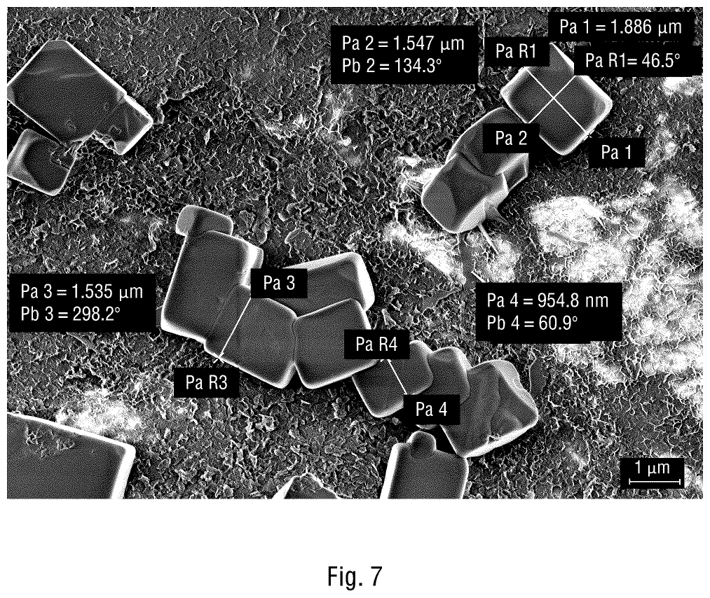

Reference is now made to FIG. 7 showing a SEM image of the high purity (<99.99%) precipitated CaCO₃ in a crystalline form. By modifying the crystallisation seeds, and the residence time in the electrochemical precipitation cell, different phases and purities of CaCO₃ crystals can be precipitated offering a novel methodology for control of CaCO₃ production.

Furthermore, when alkaline stream is utilised, decalcified water coming from this electrochemical precipitation cell and subsequentially flow it over an additional electrochemical precipitation cell containing chemically modified seeds (where for example, carboxylate groups are added to polymer beads, or MgCO₃ seeding crystals are calcined to that end), in order to partially overcome the kinetic/thermodynamic barrier of MgCO₃ precipitation, the same method can unexpectedly be used to precipitate MgCO₃, which increases the carbon capture potential of this methodology by four times by weight, with the same energy input.

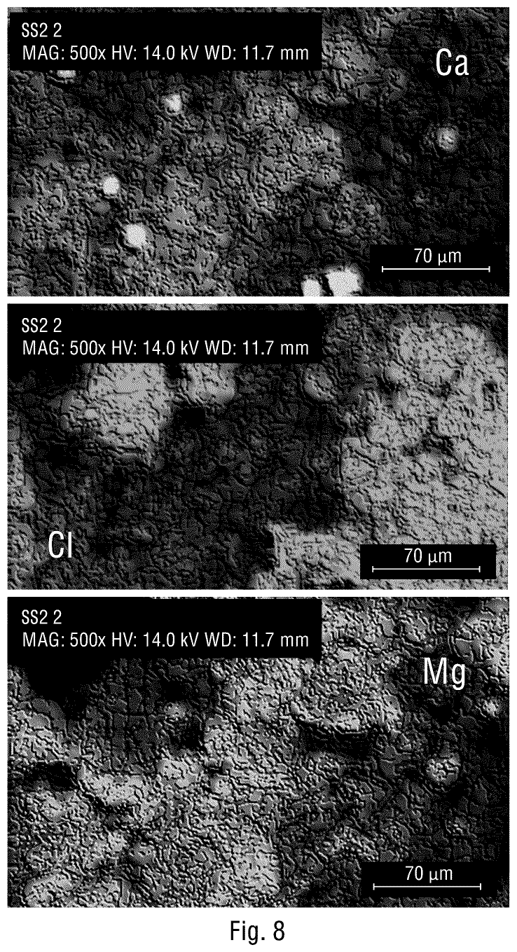

FIG. 8 shows the SEM-EDX images of the locational preference of Ca, Mg, and (Na)Cl precipitation based on the chemically modified crystallisation seeds present in the same precipitation cell. By separating the crystallisation seeds and the streams, intermixing is even further suppressed, and high purities of the minerals can be achieved.

1.-31. (canceled)

32. A combined method for carbon sequestration and water treatment, wherein 1) said carbon sequestration comprises capturing atmospheric carbon dioxide in an aqueous solution, and 2) said water treatment comprises simultaneous removal of said carbon dioxide from said aqueous solution by electrochemical deposition of metal carbonates, hydroxides and/or mixed salts crystallised on crystallisation seeds or beads.

33. The method according to claim 32, wherein said water treatment comprises the following steps:
(1) Water pumping or streaming through an electrochemical cell, in which a cathode chamber and an anode chamber are separated;
(2) Conducting a water splitting reaction by passing electric current between said cathode and said anode, thereby raising pH in the cathode chamber as a result of said water splitting reaction to produce an alkaline stream; and
(3) Feeding the alkaline stream produced in Step (2) into a crystallisation chamber containing the crystallisation seeds or beads capable of inducing a crystal growth, thereby depositing said metal carbonates, hydroxides and/or mixed salts in their crystalline form on said crystallisation seeds or beads.

34. The method according to claim 32, wherein said metal carbonates, hydroxides and mixed salts are insoluble or sparingly soluble inorganic compounds or complexes obtained from the captured carbon dioxide by chemical reactions with water and metal cations contained in said pretreated water.

35. The method according to claim 32, wherein said electrochemical cell comprises the cathode chamber and the anode chamber separated by a semipermeable membrane serving as a salt bridge.

36. The method according to claim 32, wherein the crystallisation seeds are seeding crystals serving as nucleation centres for crystal growth of the metal carbonates, hydroxides and/or mixed salts from the alkaline stream, and wherein said crystallisation seeds are optionally chemically modified with chemical functional groups to provide selective tuneable purity to the crystalline metal carbonates, hydroxides and/or mixed salts crystallised on said seeds.

37. The method according to claim 32, wherein said beads are polymeric beads structured to induce deposition and crystallisation of metal carbonates, hydroxides and/or mixed salts from the water, and wherein said beads are optionally chemically modified with chemical functional groups to provide selective tuneable purity to the crystalline metal carbonates, hydroxides and/or mixed salts crystallised on said beads.

38. The method according to claim 32, wherein said water is selected from brine, sea water, brackish water, and potable water.

39. The method according to claim 32, wherein said metal cations contained in said pretreated water are selected from both calcium and magnesium cations, iron and aluminium, said metal carbonates are selected from calcium carbonate (CaCO₃) and magnesium carbonate (MgCO₃), said mixed salt is basic magnesium carbonate ((MgOH)₂CO₃ or Mg(OH)₂*MgCO₃), and said metal hydroxides are selected from calcium hydroxide (Ca(OH)₂), magnesium hydroxide (Mg(OH)₂), iron hydroxides (Fe(OH)₂, Fe(OH)₃) and aluminium hydroxide (Al(OH)₃).

40. The method according to claim 39, wherein said method is used for descaling, anti-corrosion and biological hazard removal.

41. The method according to claim 32, further comprising the step of remineralisation, which is releasing the crystalline metal carbonates, hydroxides and/or mixed salts obtained in the method back into water, thereby restoring a mineral content of the treated water or enriching the treated water with minerals.

42. The method according to claim 33, wherein a water stream obtained from the alkaline stream after the precipitation of calcium carbonate and magnesium carbonate in Step (3) is further used for membrane-based water desalination or in cooling towers, or further returned directly to sea water.

43. The method according to claim 33, wherein CaCO₃-containing minerals and/or MgCO₃-containing minerals are further added to a water stream obtained from the alkaline stream after the precipitation of the metal carbonates, hydroxides and/or mixed salts in Step (3), in order to raise calcium and magnesium levels in said water stream.

44. The method according to claim 43, wherein the resulting stream having the increased calcium and magnesium levels is further released back into the ocean, where it is capable of capturing more carbon dioxide.

45. The method according to claim 33, wherein the electrodes in said cathode and anode chambers have a low surface area per precipitated and crystallised metal carbonates, hydroxides and/or mixed salts from water.

46. The method according to claim 45, wherein said electrodes are nanostructured electrodes comprising nanoparticles of conductive material deposited on a conductive electrode support, wherein said nanoparticles are characterised by a particle size of about 20.0 nm or less and a particle size distribution having a tuneable standard deviation within the range of approximately ±0.1 nm to ±1.0 nm.

47. The method according to claim 46, wherein said particle size of the nanostructured electrode is measured with a differential mobility analyser configured to select particle sizes, and said tuneable standard deviation is optionally adjusted by tuning a sheath flow rate of a carrier gas in the range of approximately from 1 ml/min to 25 ml/min in said differential mobility analyser, thereby tuning the standard deviation of a Gaussian distribution of the nanoparticle sizes from approximately ±0.1 nm to approximately ±2 nm.

48. The method according to claim 46, wherein said nanostructured electrode is produced by a method of spark ablation optionally combined with a differential mobility analyser to produce a particle size distribution having a tuneable standard deviation within the range of ±0.1 nm to ±1.0 nm.

49. The method according to claim 46, wherein said nanoparticles of the nanostructured electrode are stainless steel nanoparticles.

50. The method according to claim 46, wherein said conductive electrode support is a solid oxide membrane or a stainless steel.

51. The method according to claim 46, wherein the particle size of said nanoparticles of the nanostructured electrode is about 10 nm or less, or about 5 nm or less.
